(19) United States
(12) Patent Application Publication
(10) Pub. No.: US 2003/0189877 A1
(43) Pub. Date: Oct. 9, 2003

(54) Prayer clock and method for using same

(76) Inventor: David N. Bubar, Delmar, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/118,508

(22) Filed: Apr. 5, 2002

(51) Int. Cl. G04B 25/00; G04B 19/00; G04B 45/00

(52) U.S. Cl. 368/223

(57) ABSTRACT

A prayer clock and a method for organizing the offering of prayers. The prayer clock has a face region bounded by an edge. The face region may include hour numbers and at least one hand. The prayer clock includes a plurality of slots adapted to receive a note or other reminder evocative of a prayer to be offered. In one embodiment of the invention the prayer clock may be provided with words or phrases referring to prayer, or with pictures, images, or artistic representations suggestive of prayer. In another embodiment, the prayer clock may include an outer border in which the slots may be located. The slots may be associated with the hour numbers on the face of the prayer clock, thus tying a particular time to the particular prayer noted on the reminder inserted in the slot, or otherwise assisting in the organization of prayers to be offered.

### BACKGROUND OF THE INVENTION

1. Technical Field

This invention generally relates to time-keepers, and more specifically relates to a clock adapted to organize the offering of prayers.

2. Related Art

The Bible contains numerous passages referring to prayer. Many of these are injunctions or exhortations to pray, often in combination with a promise that the prayer will be heard and answered. For example, John 15:7 reads in part, “ . . . Ye shall ask what ye will, and it shall be done unto you.” James 5:15 contains the phrase, “And the prayer of faith shall heal the sick, and the Lord shall raise him up . . . ” In his first epistle to the Thessalonians, Paul instructed the people to “pray without ceasing.” (1 Thes. 5:17.) Matthew 7:7 reads “Ask, and it shall be given you; seek, and ye shall find; knock, and it shall be opened unto you.”

For those who take to heart scriptural injunctions such as these, the offering of prayer may be an important, recurring, or prominent feature of everyday life. Such people may wish to offer prayers on behalf of those they believe to be in need of divine assistance. Due to the circumstances of mortal existence, there may be many for whom such people wish to pray. Each object of these prayers may have multiple needs. It can thus be seen that the number of prayers one may wish to offer can easily be very large. This may be discouraging to one who does not wish to forget to offer even a single desired prayer. Various devices exist that are adapted to guide a person through a series of set prayers. One that is fairly well known is a rosary, which in one embodiment is a string of beads on which prayers are counted. Other feedback or counting devices similar to or based upon rosary beads also exist.

These existing devices, however, do not adequately organize prayers in terms of a person being prayed for, a reason for the prayer, or the conditions of prayer. Thus, there is a need for a device and method such that an intended prayer is less likely to be postponed or forgotten and that an intended beneficiary of such prayer receives the desired blessing or benefit when needed.

### SUMMARY OF THE INVENTION

A first aspect of the present invention provides a prayer clock, comprising:

a face region bounded by an edge, said face region comprising a plurality of hour numbers and at least one hand; and

a plurality of attachment locations associated with said hour numbers, said attachment locations adapted to receive a prayer reminder evocative of a prayer to be offered.

A second aspect of the present invention provides a method for organizing the offering of prayers, said method comprising the steps of:

creating a prayer reminder evocative of a prayer to be offered;

choosing a prayer time at which said prayer should be offered;

placing said prayer reminder in a prayer clock in a position corresponding to said prayer time;

consulting said prayer clock to determine an actual time; and

offering said prayer if said actual time is equal to said prayer time.

The present invention beneficially provides a device and method such that an intended prayer is less likely to be postponed or forgotten and that an intended beneficiary of such prayer receives the desired blessing or benefit when needed.

### BRIEF DESCRIPTION OF THE DRAWINGS

The foregoing and other features and advantages of the invention will be apparent from the following more particular description of specific embodiments of the invention, as illustrated in the accompanying drawings, wherein:

FIG. 1 is a front elevational view of a prayer clock configured according to an embodiment of the present invention;

FIG. 2 is a perspective view of a prayer clock configured according to an embodiment of the present invention; and

FIG. 3 is a flow diagram illustrating a method for organizing the offering of prayers according to one embodiment of the present invention.

It should be noted that the figures are not necessarily drawn to scale, and that elements having similar functions may in some cases be labeled using the same reference numerals.

### DETAILED DESCRIPTION OF THE INVENTION

The present invention provides a prayer clock having a face region bounded by an edge. The face region may include hour numbers and at least one hand. The prayer clock includes a plurality of slots adapted to receive a note or other reminder evocative of a prayer to be offered. In one embodiment of the invention the prayer clock may be provided with words or phrases referring to prayer, or with pictures, images, or artistic representations suggestive of prayer. In one embodiment, the prayer clock may include an outer border in which the slots may be located. The slots may be associated with the hour numbers on the face of the prayer clock, thus tying a particular time to the particular prayer noted on the reminder inserted in the slot, or otherwise assisting in the organization of prayers to be offered.

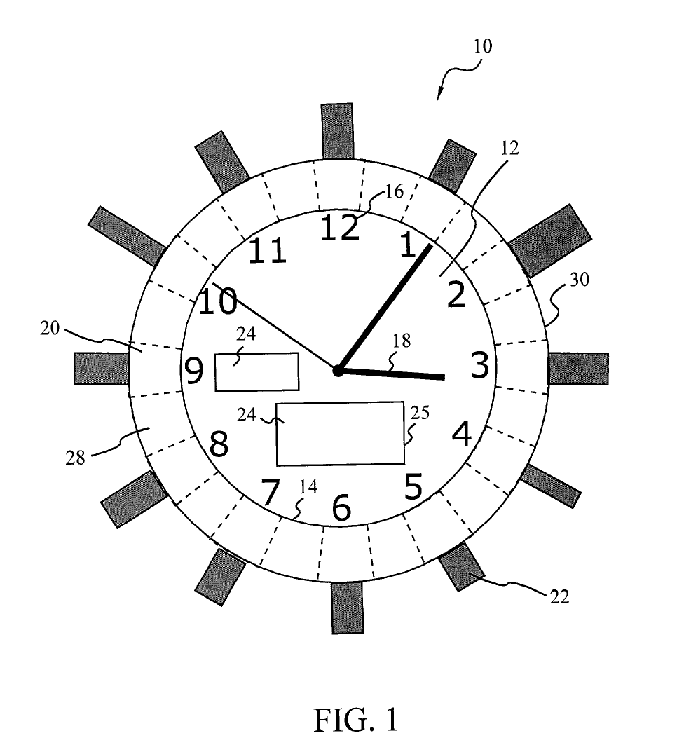

Referring now to the figures, and in particular to FIG. 1, a prayer clock 10 is shown in one embodiment wherein a face region 12 is bounded by an edge 14. Face region 12 comprises a plurality of hour numbers 16 and at least one hand 18. In this description of the invention, “hand” means any device used to point to or indicate particular hour numbers 16 for the purpose of indicating time. Hour numbers 16 and hands 18 may be arranged in a conventional manner wherein hour numbers 16 are substantially evenly spaced around face region 12 near edge 14, and hands 18 are located centrally or substantially centrally on face region 12. In one embodiment, hands 18 comprise an hour hand, a minute hand, and a second hand in a manner conventional for an analog clock. Face region 12 may be any of shape, provided only that the shape permits the clock to apprise a user of the current time. Some examples of acceptable shapes include circular, square, and rectangular.

Prayer clock 10 may further comprise at least one message area 24. Message area 24 may be adapted to display a message, not shown, composed of alphanumeric characters, where the message is viewable by a user of prayer clock 10. It may be desirable, for example, to display in message area 24 a Biblical passage referring to prayer. One of ordinary skill in the art will recognize that there are many such passages, of which only two will be reproduced here. The first, found in Matthew 7:7, lists potential rewards for praying: “Ask, and it shall be given you; seek, and ye shall find; knock, and it shall be opened unto you.” The second is also found in the book of Matthew, chapter 21, verse 22: “And all things, whatsoever ye shall ask in prayer, believing, ye shall receive.” Pictures, images, religious icons, and other artistic representations may also appear in message areas 24. These messages may, among other functions, serve to focus a user's mind on the act or the importance of prayer. As will be apparent to one of ordinary skill in the art, message area 24 may simply comprise an undefined expanse on face region 12, or its dimensions may be clearly defined by a boundary line 25 as shown in FIG. 1. There may be any number of message areas 24 included on face region 12 or elsewhere on prayer clock 10, restricted only by the total available space and by the degree of legibility desired.

Prayer clock 10 further comprises a plurality of attachment locations 20 associated with hour numbers 16. Attachment locations 20 comprise portions of prayer clock 10 adapted to receive indications, notes, or other reminders of prayers that a person wishes to offer. Attachment locations 20 may comprise openings in face region 12 into which notes may be inserted. Alternatively, they may comprise protrusions or other portions of prayer clock 10 at which it would be suitable to tape, glue, or otherwise affix a prayer reminder. Other embodiments are also possible. In the embodiment pictured in FIG. 1, for example, attachment locations 20 comprise slots 20 in which a prayer reminder 22 may be placed. In this description of the invention, “slots” means any structure suitable for holding or displaying a prayer reminder in a space between two supports. Prayer reminder 22 may be a note evocative of a prayer to be offered. Prayer reminders 22 are shown having various dimensions in FIG. 1 to suggest that they may take the form of handmade notes on which may be written a person's name, a reason the person needs to be prayed for, or some other reminder. Slots 20 may be located in an outer border 28 bounded by edge 14 and an outer perimeter 30. In the embodiment of FIG. 1, slots 20 are associated with hour numbers 16 by virtue of their location along the same radius with hour numbers 16. In other embodiments, attachment locations 20 may be associated with hour numbers 16 in other ways, such as physical proximity or a visual connection line apparent on prayer clock 10 drawn from a particular hour number 16 to a particular attachment location 20.

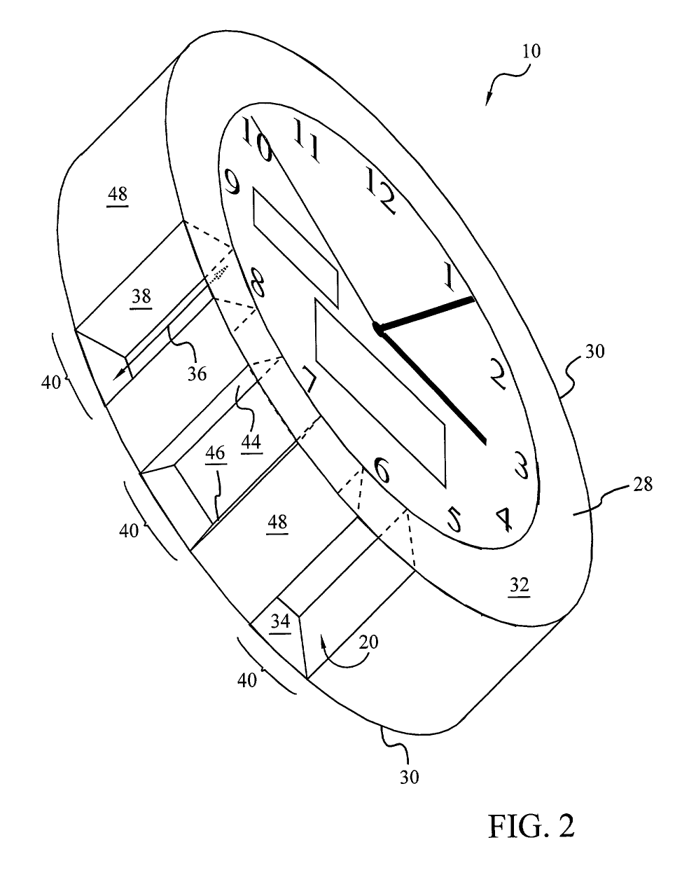

One embodiment of slots 20 is illustrated in FIG. 2, where outer border 28 comprises a top surface 32 and a bottom surface 34 separated by a gap 36. Outer perimeter 30 marks the outside boundary of prayer clock 10. Gap 36 may be of any height, provided only that it is sufficient to receive one or more prayer reminders 22. In one embodiment, gap 36 may be sized to snugly admit a prayer reminder 22 and hold it with a force sufficient to prevent it from falling out under the influence of gravity, so that prayer reminder 22 stays in place until a user of prayer clock 10 removes it. In another embodiment gap 36 may be sized to admit a plurality of prayer reminders 22, and may be provided with clips or other retaining devices, not shown, to hold prayer reminders 22 in place. Top surface 32 may be made of a transparent material so that prayer reminders 22 may be seen and read through top surface 32.

In the embodiment of FIG. 2, at least one spacer 38 is positioned between top surface 32 and bottom surface 34. Spacer 38 provides support for and helps to contain prayer reminder 22 when it is inserted in slot 20. Thus, spacer 38 may extend substantially perpendicularly between top surface 32 and bottom surface 34, and may butt snugly against those surfaces. The invention may include a plurality of spacers 38, which may be arranged in spacer pairs 40. Each spacer pair 40 comprises a first pair member 44 and a second pair member 46. In order that prayer reminders 22 may be associated with a particular time of day, spacer pairs 40 may be positioned in outer border 28 such that first pair member 44 is on one side of a particular hour number 16 and second pair member 46 is on the other side of the particular hour number 16. Spacers 38 or spacer pairs 40 may also be associated with other times besides hour numbers 16. For example, additional spacer pairs 40 could be located halfway in between each hour number 16, thereby creating an association with the half-hour marks. Other positions could create associations with the quarter hours, or with any other time.

FIG. 2 depicts a wall 48 that extends from top surface 32 to bottom surface 34 in the areas between each spacer pair 40. Wall 48 could be repositioned, or in some embodiments removed altogether, depending on the time associations desired. It should be understood that the foregoing description has described one embodiment of a slot system suitable for holding prayer reminders 22 in prayer clock 10. Other embodiments are also possible, such as a slot system in which prayer reminders 22 may be inserted through an opening in top surface 32 and wherein wall 48 is continuous around the entire perimeter of prayer clock 10. Other embodiments are also possible.

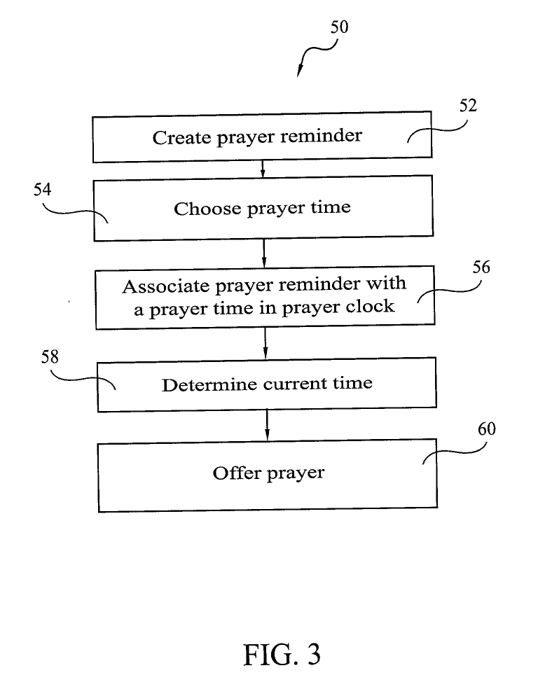

FIG. 3 illustrates a method 50 of organizing the offering of prayers according to the present invention. A first step 52 of method 50 is to create a prayer reminder. As has been described, this prayer reminder is to be evocative of a prayer to be offered. In other words, it functions to bring to a person's mind the identity of an intended beneficiary of the prayer, as well as perhaps a reason or reasons the prayer is thought to be needed. Other information relevant to the prayer that the user of the prayer clock may wish to remember may also be included in the prayer reminder. A second step 54 of method 50 is to choose a time of day at which to offer the prayer. Many factors may be relevant to this decision, and may vary from person to person and from prayer to prayer. A time may be chosen based on when the supplicant feels the prayer would be most effective. Alternatively, a time may be chosen based on its convenience to the supplicant, or for any number of other reasons.

A third step 56 of method 50 is to associate the prayer reminder created in step 52 with the prayer time chosen in step 54. This may be done by inserting the prayer reminder into the appropriate slot 20 depicted in FIG. 2, or by any other method that associates the reminder with the chosen time. A fourth step 58 of method 50 is to determine the current time as shown by the prayer clock. A fifth step 60 of method 50 is to offer a prayer if there is a prayer reminder associated with the current time shown on the prayer clock. The effectiveness of the prayer clock increases as its users increase their awareness both of the time the prayer clock is currently showing and of the presence of prayer reminders therein. Method 50 may in one embodiment include an additional step, not shown, comprising the act of removing a prayer reminder from the prayer clock at a discontinuance time. A discontinuance time is a time after which the offering of the prayer that is the subject of the prayer reminder is to be discontinued. A discontinuance time may be identified for a particular prayer if, for example, the beneficiary of the prayer receives the desired benefit or blessing. Alternatively, a user of the prayer clock may wish to offer each prayer only once, or only a set number of times or for a set number of days. Other reasons to identify a discontinuance time may also exist.

The foregoing discussion has described selected embodiments of a prayer clock having a face region bounded by an edge. As has been mentioned, the face region may include hour numbers and at least one hand. The prayer clock includes a plurality of slots adapted to receive a note or other reminder evocative of a prayer to be offered. In one embodiment of the invention the prayer clock may be provided with words or phrases referring to prayer, or with pictures, images, or artistic representations suggestive of prayer. In one embodiment, the prayer clock may include an outer border in which the slots may be located. The slots may be associated with the hour numbers on the face of the prayer clock, thus tying a particular time to the particular prayer noted on the reminder inserted in the slot, or otherwise assisting in the organization of prayers to be offered.

While the invention has been particularly shown and described with reference to selected embodiments thereof, it will be readily understood by one of ordinary skill in the art that, as limited only by the appended claims, various changes in form and details may be made therein without departing from the spirit and scope of the invention.

I claim:

1. A prayer clock, comprising:
a face region bounded by an edge, said face region comprising a plurality of hour numbers and at least one hand; and
a plurality of attachment locations associated with said hour numbers, said attachment locations adapted to receive a prayer reminder evocative of a prayer to be offered.

2. The prayer clock of claim 1, wherein said plurality of attachment locations comprises a plurality of slots adapted to receive said prayer reminder.

3. The prayer clock of claim 1 wherein said face region further comprises at least one message area, said message area adapted to display at least one message comprising at least one of: an alphanumeric character, a group of said alphanumeric characters, and an artistic representation.

4. The prayer clock of claim 3, wherein said message comprises a prayer-related message.

5. The prayer clock of claim 2, wherein said plurality of slots comprise one slot for each of said hour numbers.

6. The prayer clock of claim 2, wherein said clock further comprises an outer border surrounding said edge, said plurality of slots located in said outer border.

7. The prayer clock of claim 6, wherein said outer border comprises a top surface and a bottom surface, said top and bottom surfaces separated by a gap.

8. The prayer clock of claim 7, wherein at least one spacer is disposed in said gap, said spacer connecting said top and bottom surfaces and oriented substantially perpendicularly thereto.

9. The prayer clock of claim 8, wherein said at least one spacer comprises a plurality of spacers, said spacers arranged in spacer pairs comprising a first pair member and a second pair member, each of said spacer pairs associated with a time indicated by said prayer clock, said first pair member and said second pair member spaced apart such that said prayer reminder may be inserted between said first pair member and said second pair member.

10. The prayer clock of claim 7, wherein said top surface is constructed from a transparent material.

11. A prayer clock, comprising:
a face region bounded by an edge, said face region comprising hour numbers, at least one message area, and at least one hand, said hour numbers located substantially along said edge, said hand located on said face region interior to said hour numbers, said message area adapted to display at least one prayer-related message comprising at least one of: an alphanumeric character, a group of said alphanumeric characters, and an artistic representation;
a plurality of slots associated with said hour numbers, one of said slots for each of said hour numbers, said slots adapted to receive a prayer reminder evocative of a prayer to be offered; and
an outer border surrounding said edge and containing said plurality of slots, said outer border comprising a top surface and a bottom surface separated by a gap, wherein said gap comprises a plurality of spacers, said spacers connecting said top and bottom surfaces and oriented substantially perpendicularly thereto, said spacers arranged in spacer pairs comprising a first pair member and a second pair member, one of said spacer pairs associated with each of said hour numbers, said first pair member and said second pair member spaced apart such that said prayer reminder may be inserted between said first pair member and said second pair member, and wherein said top surface is constructed from a transparent material.

12. A method for organizing the offering of prayers, said method comprising the steps of:
creating a prayer reminder evocative of a prayer to be offered;
choosing a prayer time at which said prayer should be offered;
placing said prayer reminder in a prayer clock in a position corresponding to said prayer time;
consulting said prayer clock to determine an actual time; and
offering said prayer if said actual time is equal to said prayer time.

13. The method of claim 12, wherein said step of creating a prayer reminder comprises the step of writing at least the name of a person to be prayed for on a piece of paper.

14. The method of claim 12, wherein said step of creating a prayer reminder comprises writing at least the name of a person to be prayed for and the reason for the prayer on a piece of paper.

15. The method of claim 12, wherein said step of placing said prayer reminder in a prayer clock comprises the step of positioning said prayer reminder such that it may be perceived by a person viewing said clock.

16. The method of claim 12, further comprising the step of removing said prayer reminder from said prayer clock at a discontinuance time, said discontinuance time comprising a time after which the offering of said prayer is to be discontinued.
